(19) United States
(12) Patent Application Publication
(10) Pub. No.: US 2003/0058599 A1
(43) Pub. Date: Mar. 27, 2003

(54) Mail transmission system using mobile telephone capable of transmitting data

(75) Inventor: Masayuki Kushita, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/243,773

(22) Filed: Sep. 16, 2002

(30) Foreign Application Priority Data
Sep. 21, 2001 (JP) 289195/2001

(51) Int. Cl. H01H 73/00

(52) U.S. Cl. 361/115

(57) ABSTRACT

An external device can generate data file in a predetermined data format by using editing capabilities. The contents of the file are transferred to the mobile telephone together with a control data depending on a format. A mobile telephone performs a new mail generation and transmission/storage processes according to the received command and code. The code of an ‘on-hook’ key can be transmitted at a start and an end of the code transmission to completely return the mobile telephone to the wait state. The mobile telephone performs the new mail generation and transmission/storage processes according to the received command and code.

### BACKGROUND OF THE INVENTION

1. Field of the Invention

The present invention relates to a handy mail transmission system using a mobile telephone, and more particularly, to system capable of easily mailing text data generated by a personal computer (PC) and a personal digital assistant (PDA) from a mobile telephone having mailing capabilities using an external keyboard interface of the mobile telephone.

2. Description of the Related Art

Recently, Internet services using mobile telephones have been popularized, and electronic mail including long sentences using kanji characters can be transmitted/received. Since character input using only the keys of a mobile telephone is complicated and requires a larger number of inputting operations, e.g., sentences including kana and kanji characters. Therefore, mobile telephone service companies regulate the external keyboard interface, and manufacture and sell external keyboards capable of inputting Roman characters, etc.

Japanese Laid-Open Patent Application 2001-53889 discloses the invention of easily generating a long message including kanji characters using a touch panel input unit for exclusive use for character input, and transmitting the message to a mobile telephone, thereby mailing it to the mobile telephone of the other party.

Although an external keyboard aims at externally key-inputting data by replacing the keys of a mobile telephone, and is provided with a larger number of keys for direct input than the mobile telephone, there is insufficient space for the keys in size and pitch. As a result, it is not easy to input data on the external keyboard as compared with the keyboard of a PC.

Furthermore, the external keyboard does not have any function of generating text data in advance, and storing it. Therefore, to send electronic mail of the text data generated by a PC and a PDA by using a mobile telephone, a connection to an access point of a contract service provider is required using a modem card, etc.

In the touch panel input device described in Japanese Laid-Open Patent 2001-53889, a key-scanning operation is performed each time a character is input, code data is generated, and the generated data is transmitted to a mobile telephone. Therefore, the text data generated in advance cannot be automatically transmitted to the mobile telephone without any operation by a user. Furthermore, the touch panel is not easily operated, and does not allow high-speed input.

### SUMMARY OF THE INVENTION

An aspect of the present invention is to solve the above-mentioned problems and provide a mail transmission system using a mobile telephone capable of easily transmitting text data generated in advance by a PC or a PDA as electronic mail only using a mail service for a mobile telephone without a special circuit such as a modem card.

To solve the above mentioned problem, a mail transmission system using a mobile telephone of the present invention comprises a first device, a second device and a connecting means for connecting the first device with the second device. The first device comprises inputting means for inputting data, adding means for adding code to the data and transmitting means for transmitting the data with the code. The second device comprises receiving means for receiving the data with the code and controlling means for carrying out an operation in accordance with the code. The data is generated using editing capabilities at the first device. The operation is at least one of transmitting the data and storing the data.

The code comprises a command header portion indicating a command of the first device, a table type portion indicating a type of half-size, full-size or control, and a control code portion indicating a character code. The code is attached to each character or a plurality of characters in the data, and the data is transferred to the second device. The code comprises an on-hook command at its head and tail. The code may comprise a command header portion indicating a command of the first device, a table type portion indicating a type of half-size, full-size or control, a control code portion indicating a character code and a control code number portion indicating a length of the control code portion. The code is attached to a predetermined number of characters in the data, and the data is transferred to the second device. The code comprises an on-hook command at its head and tail. The connecting means is preferably either a start-stop synchronization serial communications cable or an infrared communications device having start-stop synchronization capabilities. The first device comprises changing means for changing the code in accordance with a format of the data. The first device and the second device are preferably a personal computer and a portable telephone, respectively.

Another aspect of the invention provides a radio communication device comprising receiving means for receiving data with a code, judging means for judging the code, transmitting means for transmitting the data in accordance with the code, storing means for storing the data in accordance with the code, input means for input information and controlling means for transmitting the data stored in the storing means in response to the information. The data is generated using editing capabilities. The code may comprise a command header portion indicating a sender of the data, a table type portion indicating a type of half-size, full-size or control, and a control code portion indicating a character code. The code is attached to each character or a plurality of characters in the data. The code comprises an on-hook command at its head and tail. The code may comprise a command header portion indicating a sender of the data, a table type portion indicating a type of half-size, full-size or control, a control code portion indicating a character code, and a control code number portion indicating a length of the control code portion. The code is attached to a predetermined number of characters in the data. The code comprises an on-hook command at its head and tail. The code is changed in accordance with a format of the data. The radio communication device is preferably a portable telephone.

Further, a mail transmission system of the present invention comprises a first device, a second device and a connector that connects the first device with the second device. The first device comprises an input circuit that inputs data, an adding circuit that adds code to the data and a transmitter that transmits the data with the code. The second device comprises a receiver that receives the data with the code and a controller that carries out an operation in accordance with the code. The data is generated using editing capabilities at the first device. The operation is at least one of transmitting the data and storing the data. The code may comprise a command header portion indicating a command of the first device, a table type portion indicating a type of half-size, full-size or control and a control code portion indicating a character code. The code is attached to each character or a plurality of characters in the data, and the data is transferred to the second device. The code comprises an on-hook command at its head and tail. The code may comprise a command header portion indicating a command of the first device, a table type portion indicating a type of half-size, full-size or control, a control code portion indicating a character code, and a control code number portion indicating a length of the control code portion. The code is attached to a predetermined number of characters in the data, and the data is transferred to the second device. The code comprises an on-hook command at its head and tail. The connector is either a start-stop synchronization serial communications cable or an infrared communications device having start-stop synchronization capabilities. The first device comprises a changer that changes the code in accordance with a format of the data. The first device and the second device are a personal computer and a portable telephone, respectively.

Moreover, a radio communication device according to the present invention comprises a receiver that receives data with a code, a judging circuit that judges the code, a transmitter that transmits the data in accordance with the code, a storing circuit that stores the data in accordance with the code, an input circuit that inputs information and a controller that transmits the data stored in the storing circuit in response to the information. The data is generated using editing capabilities. The code may comprise a command header portion indicating a sender of the data, a table type portion indicating a type of half-size, full-size or control and a control code portion indicating a character code. The code is attached to each character or a plurality of characters in the data. The code comprises an on-hook command at its head and tail. The code may comprise a command header portion indicating a sender of the data, a table type portion indicating a type of half-size, full-size or control, a control code portion indicating a character code and a control code number portion indicating a length of the control code portion. The code is attached to a predetermined number of characters in the data. The code comprises an on-hook command at its head and tail. The code is changed in accordance with a format of the data. The radio communication device is preferably a portable telephone.

According to the above mentioned present invention, the text data generated in advance by a PC or a PDA can be easily transmitted as electronic mail only using a mail service of the mobile telephone without installing a special circuit such as a modem card. Therefore, the user having the external device can generate/transmit mail including long sentences without inputting characters requiring complicated character input on the mobile telephone, and without manually re-inputting for mailing on the mobile telephone side the sentence data already generated on the external device.

Further, the present invention can generate and transmit mail by the mobile telephone itself using the existing external device and the external interface, no modifications of the existing hardware are required, but some functions of software are added to the external device. Therefore, the system can be generally applied.

### BRIEF DESCRIPTION OF THE DRAWINGS

These and other aspects, features and advantages of the invention will become more fully apparent from the following detailed description taken in conjunction with accompanying drawings. In the drawings:

FIG. 1 shows an outline of a mail transmission system according to the present invention;

FIG. 2 is a block diagram of a mobile telephone;

FIG. 3 shows a format of a command transmitted from an external device;

FIG. 4 shows an example of a display for explanation of a method of generating/transmitting/storing mail using a mobile telephone;

FIG. 5 shows a sequence for explanation of an operation of the mail transmission system according to the present invention;

FIG. 6 shows an example of a file generated by the external device;

FIG. 7 is a chart for explanation of a method of generating a text memo using a mobile telephone;

FIG. 8 shows a sequence for explanation of another embodiment of the present invention;

FIG. 9 shows another example of a file generated by the external device; and

FIG. 10 shows an example of another format of a command transmitted by the external device.

### DETAILED DESCRIPTION OF THE EMBODIMENTS

Hereinafter, each embodiment of the present invention will be described in detail with reference to the drawings.

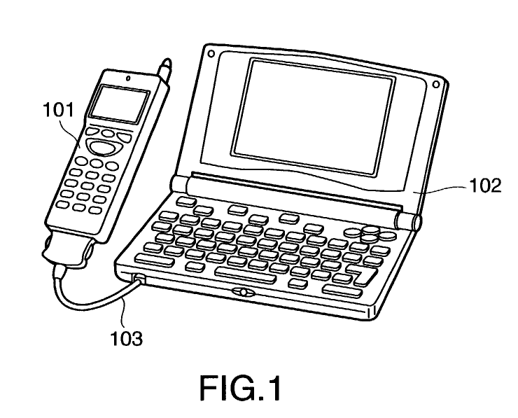

FIG. 1 shows an example of a configuration according to the present invention. A mobile telephone 101 and an external device 102, e.g, a PC or a PDA, are connected by a cable 103 for communications through a serial interface.

The text data generated by the external device 102 is transmitted as a control code through the cable 103 to the mobile telephone 101 by using a signal format of the external keyboard.

New mail is generated on the mobile telephone 101, and an operation corresponding to the key operation to be performed for transmission is carried out as if the key operation on the mobile telephone 101 were performed by transmitting a key code and a character code as a control code from an external interface.

Thus, the text data generated in advance by the external device 102, e.g., a PC or a PDA, can be easily transmitted as electronic mail only using a mail service of the mobile telephone 101 without installing any special circuit such as a modem card.

Additionally, the user having the external device 102 can generate/transmit mail including long sentences without inputting characters requiring complicated character input on the mobile telephone 101, and without manually re-inputting for mailing on the mobile telephone 101 the sentence data already generated on the external device 102.

Furthermore, since the system can be realized by using the existing external device 102 and the external interface 103, no modifications of the existing hardware are required, but some functions of software are added to the external device 102. Therefore, the system can be generally applied.

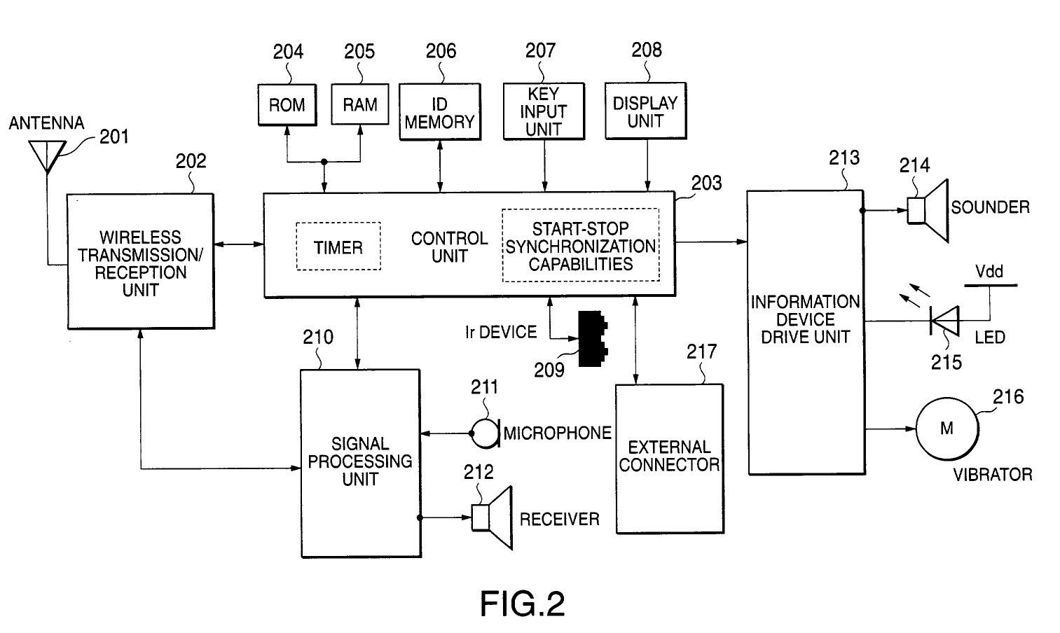

FIG. 2 shows an example of a configuration of the mobile telephone 101. A unit for controlling each portion in a control unit 203 detects the calling number of the mobile telephone 101 from a signal demodulated by a wireless transmission/reception unit 202. The control unit 203 controls a information device drive unit 213 to inform of an incoming call using sound from a sounder 214, light from a LED 215, and vibration from a vibrator 216. The control unit 203 also processes a digital data signal which is not an audio signal, thereby realizing mail transmission/reception capabilities and server connection capabilities. Normally, the control unit 203 comprises time count means such as a timer.

The calling number of the mobile telephone 101 (outgoing number) is stored in ID memory 206, and read by the control unit 203 for matching with the data in a predetermined position of a demodulation signal. The ROM 204 stores an operation program of the CPU of the control unit and fixed data, and the RAM 205 holds data of the mail received by the mail transmitting/receiving functions, the mail generated and transmitted, etc., and uses the data for work such as a CPU operation.

A signal processing unit 210, e.g., a DSP, performs an analog to digital conversion of an audio signal input through a microphone 211 under control of the control unit 203 and compresses it. The signal processing unit 210 modulates the compressed signal by the wireless transmission/reception unit 202, which generates audio data for transmission through an antenna 201. The signal processing unit 210 also extracts voice data from a signal received by the antenna 201 and demodulated by the wireless transmission/reception unit 202. After the voice signal has been demodulated, the signal processing unit performs an extending process for D/A conversion, and generates an audio signal for output from a receiver 212.

An external connector 217, typically as a 16-core connector in a PDC type mobile telephone, is connected to external equipment through an exclusive cable, and is used as an entry of data communications with the external equipment using the start-stop synchronization capabilities in the control unit 203.

An IR device 209 for infrared communications is also connected to the start-stop synchronization capabilities including an infrared communications modulation/demodulation circuit in the control unit 203, and is used as an entry of the data communications with the external equipment having the infrared communications capabilities.

A key input unit 207 is used in inputting a telephone number when a telephone call is made, inputting text by generating outgoing mail, registering data in a telephone book, etc., and inputting settings of each function. A display unit 208 displays a telephone number when a call is transmitted and received, various input contents working with the key input unit 207, the contents of the text mail received by the electronic mail transmission/reception capabilities, etc.

The antenna 201 transmits/receives an signal whose phase has been modulated. The wireless transmission/reception unit 202 demodulates the signal received from the antenna 201, and modulates the phase of the digital signal from the control unit 203 or the signal processing unit 210.

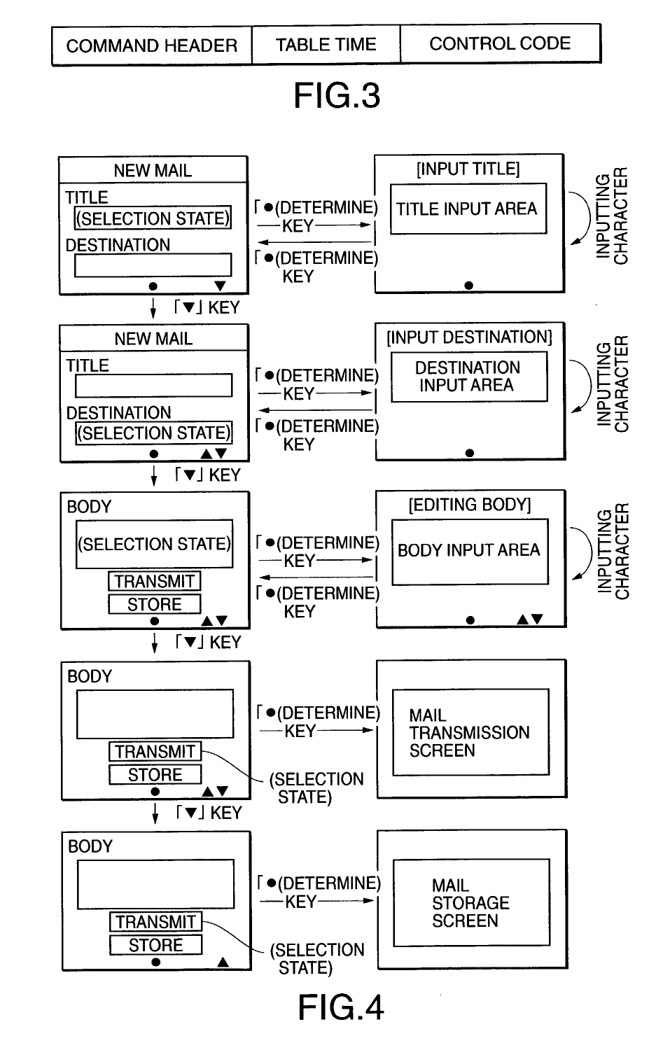

FIG. 3 shows an outline of the signal format of a command transmitted from the external device to the mobile telephone. A command comprises a header portion indicating the command for an external keyboard, a portion indicating the type of table, e.g., half size, full size, kanji or control, and a control code portion indicating a character code, a code corresponding to a key of a mobile telephone. Normally, a character table and a control table corresponding to the table type are prepared commonly in the external keyboard and the mobile telephone, and the control table contains a code corresponding to the key of the mobile telephone. In addition, the contents of the command transmitted to the mobile telephone are changed depending on the format of the file of the external device.

FIG. 4 shows an example of an operation flow of generating new transmission mail by a mobile telephone. By inputting a ‘mail’ key in a wait state, a list of mailing capabilities is displayed (not shown in the attached drawings). In the state, a ‘4’ key is input to select ‘generating new mail’, thereby entering a new mail generation screen. On the new mail generation screen, every time ‘▾’ key is input, an object to be selected can be changed ‘title’→‘destination’→‘transmission’→‘store’. If a ‘● (determine)’ key is input after the selection state, each of the execution state is entered. If the ‘▾ (determine)’ key is input after selecting ‘title’, ‘destination’, or ‘text’, then each state in which the corresponding contents can be input is entered, a character can be input, the ‘● (determine)’ key is input, the contents are determined, and control is returned to the previous selection state with the contents input.

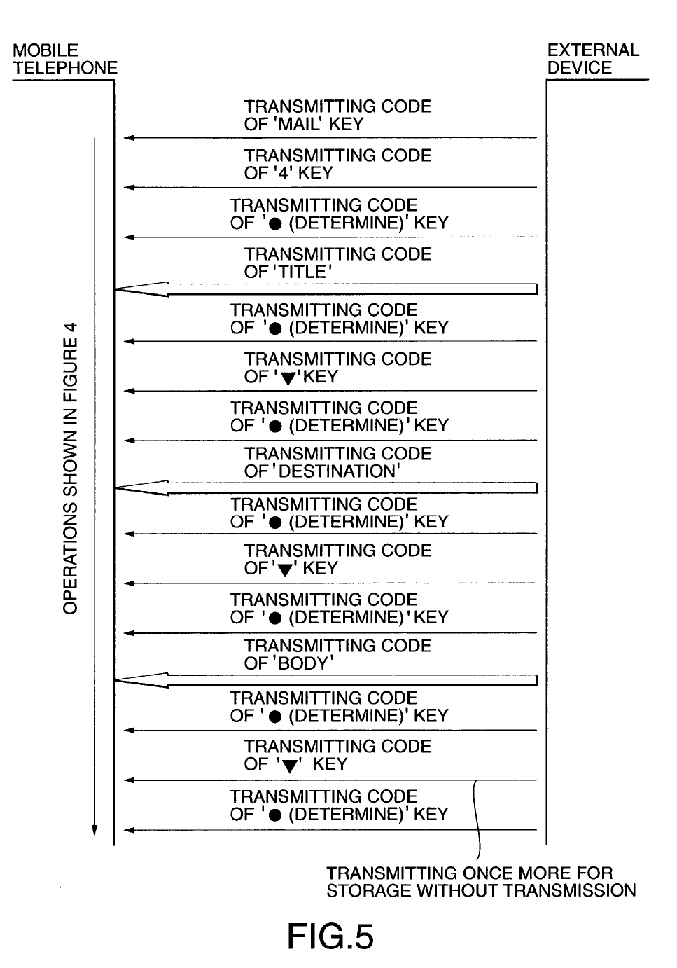

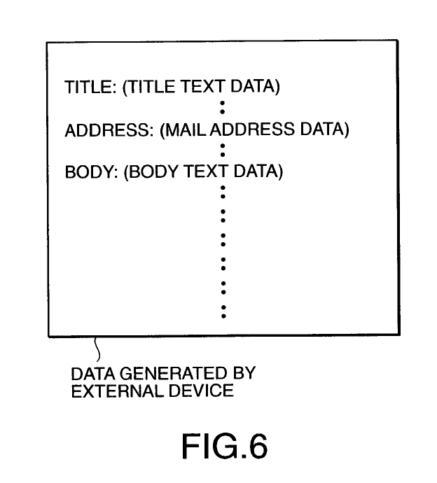

FIG. 5 shows a sequence of an embodiment of the present invention. FIG. 6 shows an example of the data generated by an external device side. The external device can generate data (file) in the format of ‘data generated by an external device’ as shown in FIG. 6 using the editing capabilities. In the state of the file opened, the ‘function of transferring data to a mobile telephone (transmission/storage can be selected)’ can be realized.

In the above mentioned ‘function of transferring data to a mobile telephone’, it is determined that the data is the transmission mail data from the format of the above mentioned ‘data generated by an external device’, and the key code and the character code are transmitted while switching the table type based on the format of the external keyboard command signal shown in FIG. 3 to allow the mobile telephone to perform the new mail generating operation shown in FIG. 4.

Although not shown in the attached drawings, the code of the ‘onhook’ key can be transmitted at the start and the end of the code transmission to completely return the mobile telephone to the wait state.

The mobile telephone performs the new mail generation and transmission/storage processes shown in FIG. 4 according to the received command and code.

The above mentioned file can be stored as data other mail data. Normally, when characters are input in the mobile telephone, an operation of confirming a character or a word is performed for kana/kanji conversion or other conversions. In the method of inputting a character using an external keyboard interface, a character code for kanji, etc. is directly transmitted.

A file received from the external device can be stored in a memory area as text data other than mail data.

In this case, the communications from the external device to the mobile telephone can be realized by the start-stop synchronization serial communications connected by an exclusive cable or by the IR (infrared) communications, etc. without a cable connection.

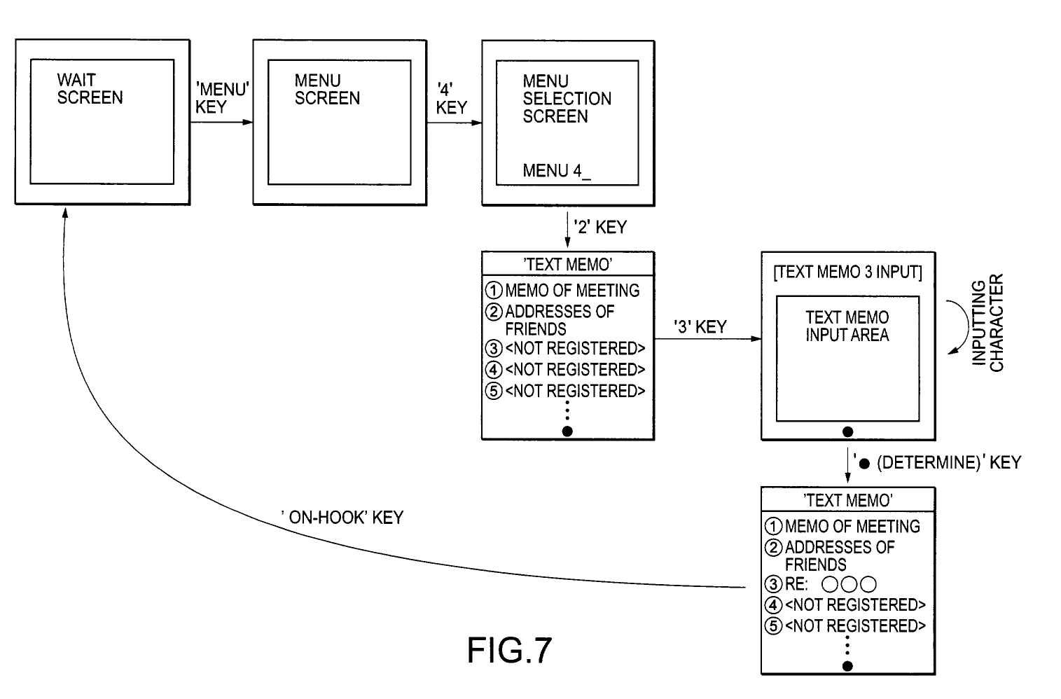

FIG. 7 shows an example of an operation flow of generating a text memo by a mobile telephone. However, in this case, it is assumed that a text memo capability is assigned to the ‘menu 42’.

By inputting the ‘menu’ key in the wait state, control is passed to the menu list display. When the ‘4’ key is input in the state, the mobile telephone moves to a state that waits the second digit of menu number to be input. If the ‘2’ key is input, the text memo list screen is entered. When a numeric key corresponding to the text memo number to be selected is input (the ‘3’ key in the drawing), the text memo contents input/edit state is entered, and a character can be input. When the ‘● (determine)’ key is input to confirm the contents, control is returned to the text memo list screen with the contents displayed. Afterwards, when the ‘on-hook’ key is input, the wait screen is entered.

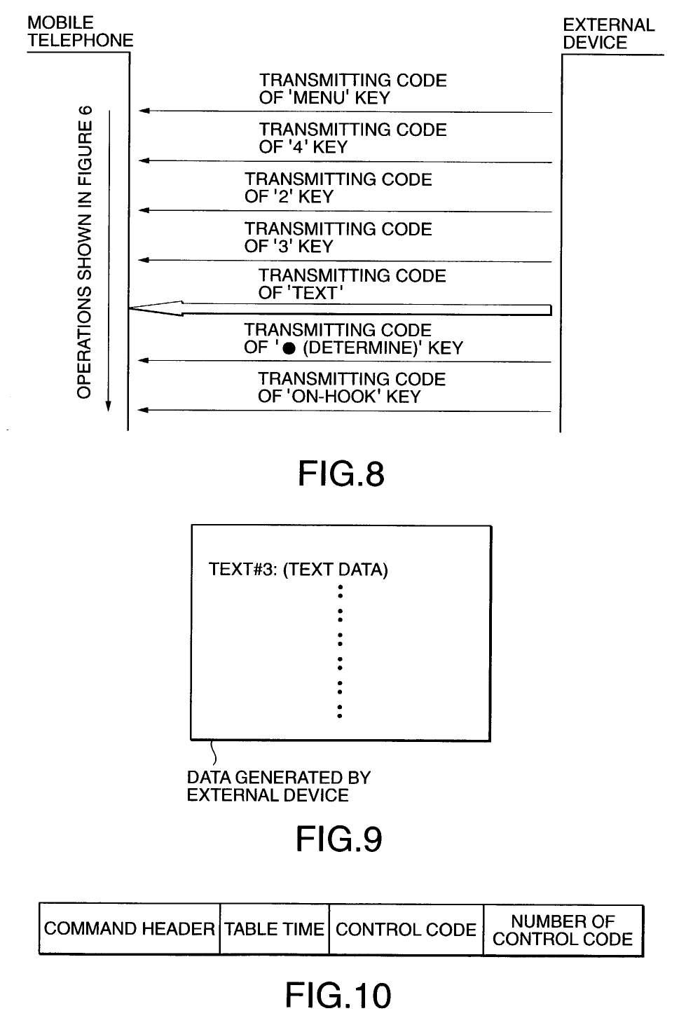

FIG. 8 shows a sequence of an embodiment of the present invention. The external device can generate data (file) in the format of the data generated by an external device side shown in FIG. 9 using the editing capabilities. In the state of the file opened, the ‘function of transferring data to a mobile telephone’ can be realized.

In the above mentioned ‘function of transferring data to a mobile telephone’, it is determined that the data is the text memo data from the format of the above mentioned ‘data generated by an external device’, and the key code and the character code are transmitted while switching the table type based on the format of the external keyboard command signal shown in FIG. 3 to allow the mobile telephone to perform the text memo generating operation shown in FIG. 6. The mobile telephone performs the text memo generation process shown in FIG. 7 according to the received command and code.

Normally, when characters are input at the mobile telephone, an operation of confirming a character or a word is performed for kana/kanji conversion or other conversions. In the method of inputting a character using an external keyboard interface, a character code for kanji or other characters is directly transmitted. Therefore, the confirmation is carried out finally only.

The mobile telephone can copy the contents of the text memo to the contents of the new mail using the copying and pasting capabilities, and then can mail them.

When the external keyboard command signal format shown in FIG. 3 is used, a command header is added each time one-character code is transmitted. Therefore, the overhead becomes large when the data portion is transmitted. Therefore, a command header is separately defined as shown in FIG. 8 to provide a portion indicating the length of a control code field in the format so that a plurality of control (character) codes can be simultaneously transmitted.

If it is determined that a code not normally used as a character indicates an end, a plurality of control (character) codes can be simultaneously transmitted without a portion indicating the length of the control code field. Whether or not the determination is to be made can be specified for each table type.

Obviously, numerous additional modifications and variations of the present invention are possible in light of the above teachings. It is, therefore, to be understood that within the scope of the appended claims, the invention may be practiced otherwise than as specifically described herein.

What is claimed is:

1. A mail transmission system, comprising:
a first device;
a second device; and
a connecting means for connecting said first device with said second device, wherein said first device comprises:
inputting means for inputting data;
adding means for adding code to said data; and
transmitting means for transmitting said data with said code;
wherein said second device comprises:
receiving means for receiving said data with said code;
controlling means for carrying out an operation in accordance with said code.

2. The mail transmission system as claimed in claim 1, wherein said data is generated using editing capabilities at said first device.

3. The mail transmission system as claimed in claim 1, wherein said operation is at least one of transmitting said data and storing said data.

4. The mail transmission system as claimed in claim 3, wherein said code comprises:
a command header portion indicating a command of said first device;
a table type portion indicating a type of half-size, full-size, or control; and
a control code portion indicating a character code,
wherein said code is attached to each character or a plurality of characters in said data, and said data is transferred to said second device.

5. The mail transmission system as claimed in claim 4, wherein said code comprises an on-hook command at at least one of its head and its tail.

6. The mail transmission system as claimed in claim 3, wherein said code comprises:
a command header portion indicating a command of said first device;
a table type portion indicating a type of half-size, full-size, or control;
a control code portion indicating a character code, and a control code number portion indicating a length of said control code portion,
wherein said code is attached to a predetermined number of characters in said data, and said data is transferred to said second device.

7. The mail transmission system as claimed in claim 6, wherein said code comprises an on-hook command at at least one of its head and its tail.

8. The mail transmission system as claimed in claim 1, wherein said connecting means is either a start-stop synchronization serial communications cable or an infrared communications device having start-stop synchronization capabilities.

9. The mail transmission system as claimed in claim 1, wherein said first device comprises changing means for changing said code in accordance with a format of said data.

10. The mail transmission system as claimed in claim 9, wherein said first device and said second device are a personal computer and a portable telephone, respectively.

11. A radio communication device, comprising:
receiving means for receiving data with a code;
judging means for judging said code;
transmitting means for transmitting said data in accordance with said code;
storing means for storing said data in accordance with said code;
input means for input information; and
controlling means for transmitting said data stored in said storing means in response to said information.

12. The radio communication device as claimed in claim 11, wherein said data is generated using editing capabilities.

13. The radio communication device as claimed in claim 11, wherein said code comprises:
a command header portion indicating a sender of said data;
a table type portion indicating a type of half-size, full-size, or control; and
a control code portion indicating a character code,
wherein said code is attached to each character or a plurality of characters in said data.

14. The radio communication device as claimed in claim 13, wherein said code comprises an on-hook command at at least one of its head and its tail.

15. The radio communication device as claimed in claim 11, wherein said code comprises:
a command header portion indicating a sender of said data;
a table type portion indicating a type of half-size, full-size, or control;
a control code portion indicating a character code, and a control code number portion indicating a length of said control code portion,
wherein said code is attached to a predetermined number of characters in said data.

16. The radio communication device as claimed in claim 15, wherein said code comprises an on-hook command at at least one of its head and its tail.

17. The radio communication device as claimed in claim 11, wherein said code is changed in accordance with a format of said data.

18. The radio communication device as claimed in claim 17, wherein said radio communication device is a portable telephone.

19. A mail transmission system, comprising:
a first device;
a second device; and
a connector that connects said first device with said second device,
wherein said first device, comprising:
an input circuit that inputs data;
an adding circuit that adds code to said data; and
a transmitter that transmits said data with said code;
wherein said second device, comprising:
a receiver that receives said data with said code; and
a controller that carries out an operation in accordance with said code.

20. The mail transmission system as claimed in claim 19, wherein said data is generated using editing capabilities at said first device.

21. The mail transmission system as claimed in claim 19, wherein said operation is at least one of transmitting said data and storing said data.

22. The mail transmission system as claimed in claim 21, wherein said code comprises:
a command header portion indicating a command of said first device;
a table type portion indicating a type of half-size, full-size, or control; and
a control code portion indicating a character code,
wherein said code is attached to each character or a plurality of characters in said data, and said data is transferred to said second device.

23. The mail transmission system as claimed in claim 22, wherein said code comprises an on-hook command at at least one of its head and its tail.

24. The mail transmission system as claimed in claim 21, wherein said code comprises:
a command header portion indicating a command of said first device;
a table type portion indicating a type of half-size, full-size, or control;
a control code portion indicating a character code, and a control code number portion indicating a length of said control code portion,
wherein said code is attached to a predetermined number of characters in said data, and said data is transferred to said second device.

25. The mail transmission system as claimed in claim 24, wherein said code comprises an on-hook command at at least one of its head and its tail.

26. The mail transmission system as claimed in claim 19, wherein said connector is either a start-stop synchronization serial communications cable or an infrared communications device having start-stop synchronization capabilities.

27. The mail transmission system as claimed in claim 19, wherein said first device comprises a changer that changes said code in accordance with a format of said data.

28. The mail transmission system as claimed in claim 27, wherein said first device and said second device are a personal computer and a portable telephone, respectively.

29. A radio communication device, comprising:
a receiver that receives data with a code;
a judging circuit that judges said code;
a transmitter that transmits said data in accordance with said code;
a storing circuit that stores said data in accordance with said code;
an input circuit that inputs information; and
a controller that transmits said data stored in said storing circuit in response to said information.

30. The radio communication device as claimed in claim 29, wherein said data is generated using editing capabilities.

31. The radio communication device as claimed in claim 29, wherein said code comprises:
a command header portion indicating a sender of said data;
a table type portion indicating a type of half-size, full-size, or control; and
a control code portion indicating a character code,
wherein said code is attached to each character or a plurality of characters in said data.

32. The radio communication device as claimed in claim 31, wherein said code comprises an on-hook command at at least one of its head and its tail.

33. The radio communication device as claimed in claim 29, wherein said code comprises:
a command header portion indicating a sender of said data;
a table type portion indicating a type of half-size, full-size, or control;
a control code portion indicating a character code, and a control code number portion indicating a length of said control code portion,
wherein said code is attached to a predetermined number of characters in said data.

34. The radio communication device as claimed in claim 33, wherein said code comprises an on-hook command at at least one of its head and its tail.

35. The radio communication device as claimed in claim 29, wherein said code is changed in accordance with a format of said data.

36. The radio communication device as claimed in claim 35, wherein said radio communication device is a portable telephone.
